(19) United States
(12) Patent Application Publication
(10) Pub. No.: US 2025/0321634 A1
(43) Pub. Date: Oct. 16, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: YUHEI TAKI, TOKYO (JP); RYOUHEI YASUDA, TOKYO (JP); KUNIHITO SAWAI, TOKYO (JP); SHIMENG PENG, TOKYO (JP); EISUKE SAKAI, TOKYO (JP)

(21) Appl. No.: 18/868,007

(22) PCT Filed: May 23, 2023
(86) PCT No.: PCT/JP2023/019149

§ 371 Date: Nov. 21, 2024

(30) Foreign Application Priority Data
May 31, 2022 (JP) 2022-088691

(51) Int. Cl. G06F 3/01; G09B 5/02; G09B 5/14

(52) U.S. Cl. CPC G06F 3/013; G09B 5/02; G09B 5/14

(57) ABSTRACT

An information processing device includes: an estimation method determination unit that determines an estimation method for estimating a degree of interest of a viewer who views content on the basis of at least a situation of the content; and a degree-of-interest estimation unit that estimates the degree of interest on the basis of the estimation method and a plurality of parameters including a parameter regarding a line-of-sight of the viewer.

### TECHNICAL FIELD

The present technology relates to an information processing device, an information processing method, and a program and particularly relates to a technology for viewing content online.

### BACKGROUND ART

For example, Patent Document 1 discloses a device that evaluates a learning state of a student (viewer) who is taking an online class on the basis of information regarding behavior of the student and presents information for assisting the progress of the online class to a teacher on the basis of the learning state.

### CITATION LIST

### Patent Document

Patent Document 1: Japanese Patent Application Laid-Open No. 2022-25223

### SUMMARY OF THE INVENTION

### Problems to be Solved by the Invention

The above device does not reflect a scene of the online class or a state of the teacher when evaluating the learning state of the student. Therefore, the above device may not accurately evaluate the learning state of the student.

Therefore, an object of the present technology is to accurately estimate a degree of interest of a viewer.

### Solutions to Problems

An information processing device according to the present technology includes: an estimation method determination unit that determines an estimation method for estimating a degree of interest of a viewer who views content on the basis of at least a situation of the content; and a degree-of-interest estimation unit that estimates the degree of interest on the basis of the estimation method and a plurality of parameters including a parameter regarding a line-of-sight of the viewer.

Therefore, the information processing device can determine an optimal estimation method according to a class situation.

### BRIEF DESCRIPTION OF DRAWINGS

FIG. 1 shows a configuration of an online class system.

FIG. 2 shows a configuration of a teacher terminal device.

FIG. 3 shows a configuration of a student terminal device.

FIG. 4 shows a configuration of a server.

FIG. 5 shows a functional configuration of a CPU.

FIG. 6 shows a class screen displayed on a display unit of a student terminal device in an online class.

FIG. 7 shows a student screen displayed on a display unit of a teacher terminal device in an online class.

FIG. 8 shows an overview of degree-of-listening calculation processing.

FIG. 9 shows identification of a class situation.

FIG. 10 shows an example of determining parameters to be used.

FIG. 11 shows an example of determining parameters to be used.

FIG. 12 shows a notification at the time of reconfirming a degree of listening.

FIG. 13 shows a first example of the notification of the degree of listening.

FIG. 14 shows a second example of the notification of the degree of listening.

FIG. 15 shows a third example of the notification of the degree of listening.

FIG. 16 shows a fourth example of the notification of the degree of listening.

FIG. 17 shows a fifth example of the notification of the degree of listening.

FIG. 18 is a flowchart showing a flow of degree-of-interest estimation notification processing.

### MODE FOR CARRYING OUT THE INVENTION

Hereinafter, an embodiment will be described in the following order.
<1. Configuration of Online Class System 1>
<2. Configuration of Teacher Terminal Device 2>
<3. Configuration of Student Terminal Device 3>
<4. Configuration of Server 4>
<5. Example of Online Class>
<6. Degree-of-Interest Estimation Notification Processing>
<7. Flow of Degree-of-Interest Estimation Notification Processing>
<8. Another Configuration Example of Online Class System 1>
<9. Summary of Embodiment>
<10. Present Technology>

### 1. Configuration of Online Class System 1

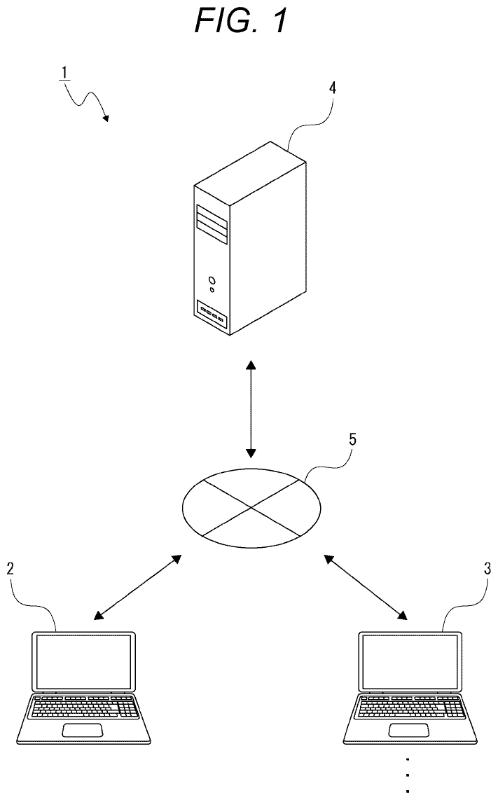

First, a configuration of an online class system 1 according to an embodiment of the present technology will be described. FIG. 1 shows a configuration of the online class system 1.

As shown in FIG. 1, the online class system 1 includes a teacher terminal device 2, a plurality of student terminal devices 3, and a server 4.

The teacher terminal device 2, the student terminal devices 3, and the server 4 are connected via a network 5 such as the Internet and can communicate with each other via the network 5.

The teacher terminal device 2 is assumed to be used by a teacher who conducts an online class. The student terminal devices 3 are assumed to be used by students who take an online class.

In the online class system 1, it is possible to conduct an online class by causing content such as a moving image of a scene of a class and a document provided (distributed) from the teacher terminal device 2 to be viewed by using the student terminal device 3.

Note that the teacher is an example of a provider who provides content, and the student is an example of a viewer who views the content, but the explainer and the viewer are not limited thereto.

### 2. Configuration of Teacher Terminal Device 2

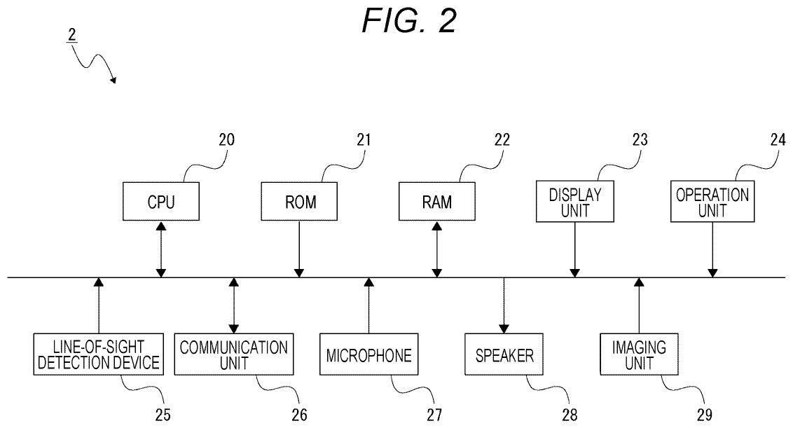

FIG. 2 shows a configuration of the teacher terminal device 2. As shown in FIG. 2, the teacher terminal device 2 is a computer including a central processing unit (CPU) 20, a read only memory (ROM) 21, and a random access memory (RAM) 23. The teacher terminal device 2 is, for example, a personal computer, a portable terminal device such as a smartphone, a tablet device, or the like.

The CPU 20 integrally controls the entire teacher terminal device 2 by developing a program stored in the ROM 21 or a storage unit (not shown) in the RAM 22 and executing the program.

The teacher terminal device 2 includes not only the CPU 20, the ROM 21, and the RAM 22, but also a display unit 23, an operation unit 24, a line-of-sight detection device 25, a communication unit 26, a microphone 27, a speaker 28, and an imaging unit 29.

The display unit 23 is a liquid crystal display, an organic light emitting diode (OLPD) display, or the like and displays various screens (images).

The operation unit 24 is an input device used by a user (here, teacher) and is, for example, various operation elements and operation devices such as a keyboard, a mouse, a button, a dial, a touch pad, and a touchscreen. When an operation is detected by the operation unit 24, a signal corresponding to the input operation is input to the CPU 20.

The line-of-sight detection device 25 is a device that detects a line-of-sight direction of the user (here, teacher). The line-of-sight detection device 25 detects the line-of-sight direction of the user by a corneal reflex method, facial feature point detection, or the like.

In a case of detecting the line-of-sight direction of the user by the corneal reflex method, the line-of-sight detection device 25 includes an infrared light source that emits infrared rays and an infrared camera that receives infrared rays and detects the line-of-sight direction of the user on the basis of an image obtained by the infrared camera receiving infrared rays emitted from the infrared light source and reflected by the pupils of the user.

In a case of detecting the line-of-sight direction of the user by the facial feature point detection, the line-of-sight detection device 25 includes a visible light camera that receives visible light, detects feature points by performing image analysis on the face of the user imaged by the visible light camera, and estimates the line-of-sight direction of the user from a direction of the face, a position of the iris, and the like.

Further, the line-of-sight detection device 25 detects a position at which the user gazes on a screen displayed on the display unit 23, that is, coordinates (X, Y) of a point of gaze on the basis of the detected line-of-sight direction of the user, a positional relationship between the line-of-sight detection device 25 and the display unit 23, and the like. Here, X represents a coordinate in a horizontal direction, and Y represents a coordinate in a vertical direction.

Note that the line-of-sight detection device 25 may be other than those described above as long as the line-of-sight direction of the user and the coordinates of the point of gaze can be detected. Further, the line-of-sight detection device 25 may detect the line-of-sight direction of the user in cooperation with the CPU 20.

The communication unit 26 communicates with the student terminal device 3 and the server 4 via the network 5.

The microphone 27 collects a voice uttered by the user (here, teacher).

The speaker 28 outputs a voice to the user (here, teacher). The imaging unit 29 is, for example, a charge coupled device (CCD) or complementary metal-oxide-semiconductor (CMOS) image sensor. The imaging unit 29 images a scene of a class conducted by the teacher.

### 3. Configuration of Student Terminal Device 3

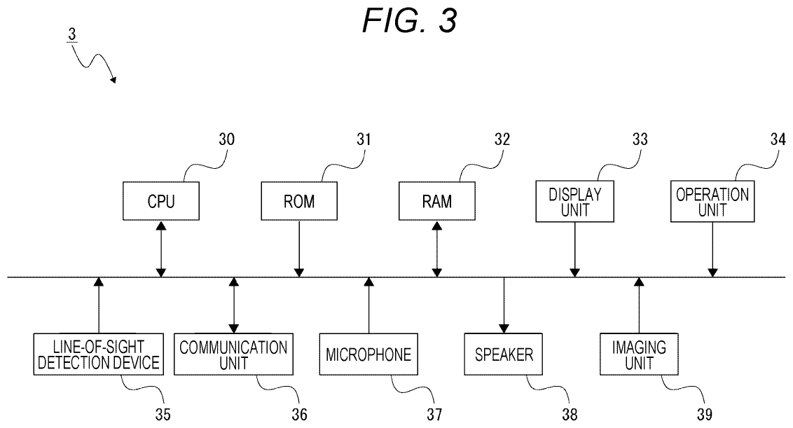

FIG. 3 shows a configuration of the student terminal device 3. As shown in FIG. 3, the student terminal device 3 is a computer including a CPU 30, a ROM 31, and a RAM 32. The student terminal device 3 is, for example, a personal computer, a portable terminal device such as a smartphone, a tablet device, or the like.

The CPU 30 integrally controls the entire student terminal device 3 by developing a program stored in the ROM 31 or a storage unit (not shown) in the RAM 32 and executing the program.

The student terminal device 3 includes not only the CPU 30, the ROM 31, and the RAM 32, but also a display unit 33, an operation unit 34, a line-of-sight detection device 35, a communication unit 36, a microphone 37, a speaker 38, and an imaging unit 39.

The display unit 33 is a liquid crystal display, an OLPD display, or the like and displays various screens (images).

The operation unit 34 is an input device used by a user (here, student) and is, for example, various operation elements and operation devices such as a keyboard, a mouse, a button, a dial, a touch pad, and a touchscreen. When an operation is detected by the operation unit 34, a signal corresponding to the input operation is input to the CPU 30.

The line-of-sight detection device 35 is a device that detects a line-of-sight direction of the user (here, student). The line-of-sight detection device 35 is configured in a similar manner to the line-of-sight detection device 25.

The communication unit 36 communicates with the teacher terminal device 2 and the server 4 via the network 5.

The microphone 37 collects a voice uttered by the user (here, student).

The speaker 38 outputs a voice to the user (here, student).

The imaging unit 39 is, for example, a CCD or CMOS image sensor. The imaging unit 39 images an upper body of the student, for example.

### 4. Configuration of Server 4

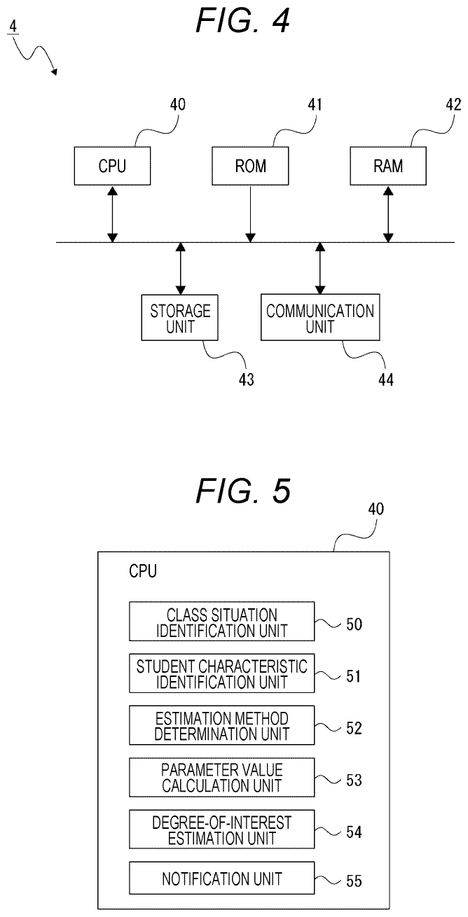

FIG. 4 shows a configuration of the server 4. FIG. 5 shows a functional configuration of a CPU 40. As shown in FIG. 4, the server 4 is a computer including the CPU 40, a ROM 41, a RAM 42, a storage unit 43, and a communication unit 44.

The CPU 40 integrally controls the entire server 4 by developing a program stored in the ROM 41 or the storage unit 43 in the RAM 42 and executing the program.

As shown in FIG. 5, the CPU 40 functions as a class situation identification unit 50, a student characteristic identification unit 51, an estimation method determination unit 52, a parameter value calculation unit 53, a degree-of-interest estimation unit 54, and a notification unit 55.

The class situation identification unit 50 identifies a class situation such as a scene of a class and a state of the teacher on the basis of class data transmitted from the teacher terminal device 2.

The student characteristic identification unit 51 identifies a student characteristic such as a characteristic or habit of the student on the basis of student data transmitted from the student terminal device 3.

The estimation method determination unit 52 determines an estimation method for estimating a degree of interest for each student described later in detail. Specifically, the estimation method determination unit 52 determines a parameter for estimating the degree of interest from among a plurality of preset parameters and weighting of the determined parameter on the basis of at least the class situation identified by the class situation identification unit 50. Therefore, the estimation method includes determination of a parameter for estimating the degree of interest and weighting of the parameter, but may include only one thereof.

The parameter value calculation unit 53 calculates a parameter value of the parameter determined by the estimation method determination unit 52.

The degree-of-interest estimation unit 54 estimates the degree of interest of each student on the basis of the parameter value calculated by the parameter value calculation unit 53.

The notification unit 55 causes the teacher terminal device 2 to make a notification based on the degree of interest estimated by the degree-of-interest estimation unit 54.

Note that details of the class situation identification unit 50, the student characteristic identification unit 51, the estimation method determination unit 52, the parameter value calculation unit 53, the degree-of-interest estimation unit 54, and the notification unit 55 will be described later.

The storage unit 43 includes, for example, a storage medium such as a solid-state memory. The storage unit 43 can store, for example, various types of information described later. Further, the storage unit 43 can also be used to store program data for the CPU 40 to execute various types of processing.

The communication unit 44 communicates with the teacher terminal device 2 and the student terminal device 3 via the network 5.

### 5. Example of Online Class

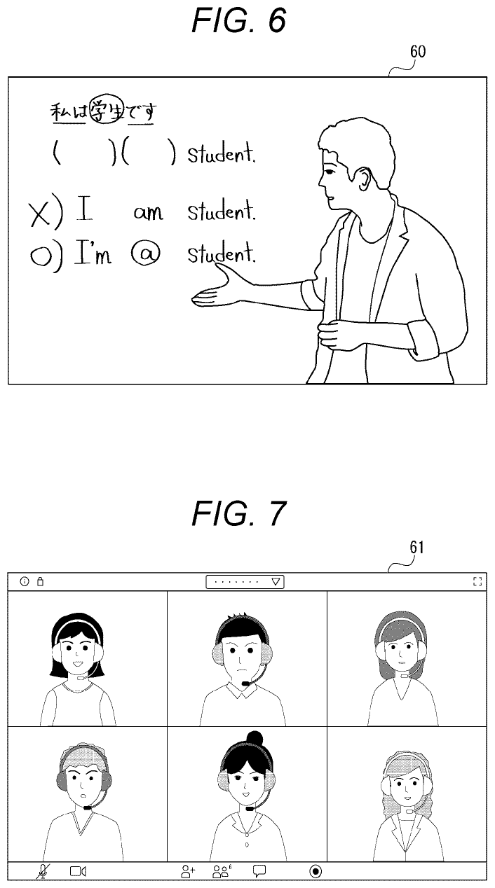

FIG. 6 shows a class screen 60 displayed on the display unit 33 of the student terminal device 3 in an online class. FIG. 7 shows a student screen 61 displayed on the display unit 23 of the teacher terminal device 2 in an online class.

In the teacher terminal device 2, the imaging unit 29 images a scene of a class to obtain a class moving image, and the microphone 27 collects a class voice. Then, the teacher terminal device 2 transmits the obtained class moving image and class voice to the student terminal device 3 and the server 4 as class data.

In the student terminal device 3 that has received the class data, as shown in FIG. 6, the class moving image included in the class data is displayed on the display unit 33 as the class screen 60. Further, in the student terminal device 3, the class voice included in the class data is output from the speaker 38.

In this manner, the online class system 1 allows a student who uses the student terminal device 3 to view a class of a teacher who uses the teacher terminal device 2 online in real time.

Further, in the student terminal device 3, the imaging unit 39 images the upper body of the student to obtain a student moving image, and the microphone 37 collects a student voice. Then, the student terminal device 3 transmits the obtained student moving image and student voice to the teacher terminal device 2 and the server 4 as student data.

In the teacher terminal device 2 that has received the student data from each of the plurality of student terminal devices 3, as shown in FIG. 7, the student screen 61 in which the student moving images (student images) included in the student data are arranged is displayed on the display unit 23. Further, in the teacher terminal device 2, the student voice included in the student data is output from the speaker 28.

In this manner, the online class system 1 allows the teacher to view states of the students who use the student terminal device 3 in real time.

By the way, it is difficult for the teacher who uses the teacher terminal device 2 to determine whether or not the student is listening to the class, that is, the degree of interest of the student in the class only by confirming the student screen 61.

Therefore, the server 4 performs degree-of-interest estimation notification processing of estimating the degree of interest (degree of listening) of the student and making a notification based on the estimated degree of interest to the teacher. Note that, while the degree-of-interest estimation notification processing is being executed, the teacher terminal device 2 transmits line-of-sight information detected by the line-of-sight detection device 25 to the server 4 as a part of the class data. Further, the student terminal device 3 transmits line-of-sight information detected by the line-of-sight detection device 35 to the server 4 as a part of the student data.

### 6. Degree-of-Interest Estimation Notification Processing

The degree-of-interest estimation notification processing includes degree-of-listening calculation processing of calculating (estimating) the degree of listening as the degree of interest of each student and notification processing of making a notification based on the calculated degree of listening to the teacher. First, the degree-of-listening calculation processing will be described, and then the notification processing will be described.

### 6.1. Degree-of-Listening Calculation Processing

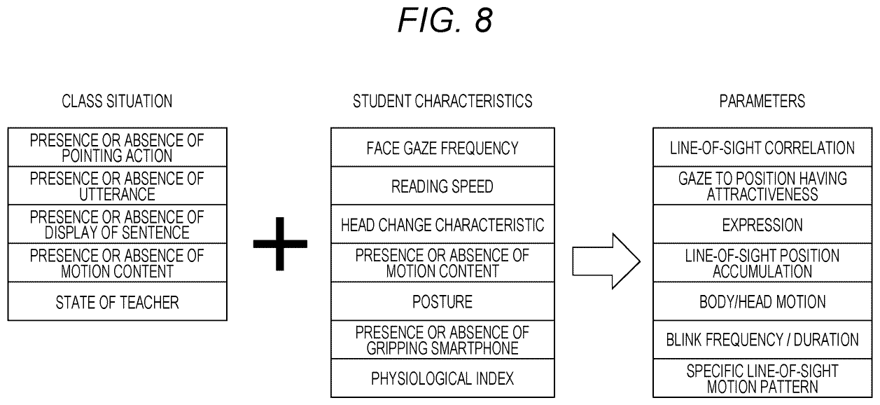

FIG. 8 shows an overview of the degree-of-listening calculation processing. In the degree-of-listening calculation processing, a class situation is identified by the class situation identification unit 50, and a student characteristic is identified by the student characteristic identification unit 51. Then, in the degree-of-listening calculation processing, as shown in FIG. 8, a parameter for calculating the degree of listening is determined by the estimation method determination unit 52 from among a plurality of parameters on the basis of the identified class situation and student characteristic. Thereafter, in the degree-of-listening calculation processing, a parameter value is calculated by the parameter value calculation unit 53, and then the degree of listening is calculated by the degree-of-interest estimation unit 54 by using the parameter value.

Hereinafter, the above processing will be specifically described.

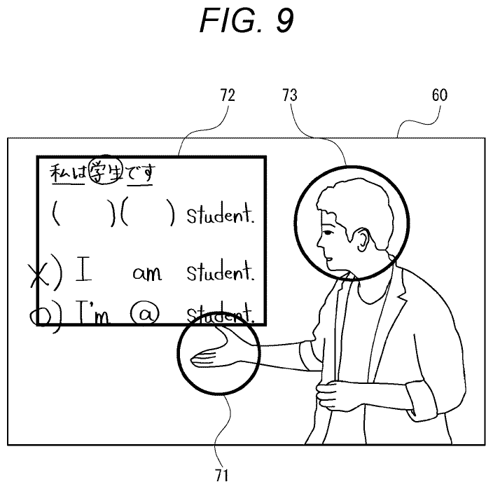

FIG. 9 shows identification of a class situation. The class situation identification unit 50 identifies a class situation on the basis of class data transmitted from the teacher terminal device 2. The class situation to be identified is information for enabling determination of what class is being conducted and includes the presence or absence of a pointing action, the presence or absence of utterance, the presence or absence of display of a sentence, the presence or absence of motion content, a state of the teacher (expression, motion), and the like as shown in FIG. 8.

The class situation identification unit 50 identifies, for example, the presence or absence of display of a sentence, the presence or absence of motion content, and the state of the teacher in a class scene by performing image analysis on a class moving image included in the class data.

More specifically, as shown in FIG. 9, the class situation identification unit 50 estimates a posture of the teacher from the class moving image by using a known posture estimation technology (bone estimation). Then, the class situation identification unit 50 identifies, for example, a state 71 in which the hand is pointing on the basis of the estimated posture of the teacher, thereby identifying the presence or absence of a pointing action.

Further, the class situation identification unit 50 performs image analysis on the class moving image to identify an area 72 where a sentence is displayed, thereby identifying the presence or absence of display of a sentence.

Further, the class situation identification unit 50 performs image analysis on the class moving image, thereby identifying the presence or absence of motion content (video content).

Further, the class situation identification unit 50 identifies the teacher's face 73 from the class moving image by using a known expression recognition technology and identifies the teacher's expression as the state of the teacher.

Further, the class situation identification unit 50 performs voice analysis on a voice included in the class data, thereby identifying, for example, the presence or absence of utterance in a class situation.

As described above, when receiving the class data from the teacher terminal device 2, the class situation identification unit 50 identifies the class situation on the basis of the received class data.

Note that each class situation item and the specification method thereof described above are merely examples, and another item may be identified as the class situation, or each class situation item may be identified by another method.

The student characteristic identification unit 51 identifies a student characteristic of each student on the basis of student data transmitted from each student terminal device 3 and stores the student characteristic in the storage unit 43. The student characteristic to be identified includes a face gaze frequency, a reading speed, a head change characteristic, a posture, the presence or absence of gripping a smartphone, a physiological index, and the like as shown in FIG. 8.

Specifically, the student characteristic identification unit 51 identifies a point of gaze of the student on the class screen 60 on the basis of the class moving image included in the class data and line-of-sight information included in the student data. Then, the student characteristic identification unit 51 identifies a frequency at which the student gazes at the teacher's face while the teacher is uttering words as the face gaze frequency.

Further, the student characteristic identification unit 51 calculates a moving speed of the line-of-sight when a sentence is displayed on the class moving image and the student is gazing at the sentence as the reading speed.

Further, the student characteristic identification unit 51 identifies the student's expression from a student moving image included in the student data by using the known expression recognition technology. Then, the student characteristic identification unit 51 identifies a head change characteristic such as blink frequency and head motion on the basis of a change in the identified student's expression.

Further, the student characteristic identification unit 51 estimates a posture of the student from the student moving image included in the student data by using the known posture estimation technology (bone estimation). Then, the student characteristic identification unit 51 identifies, for example, the presence or absence of gripping a smartphone and a physiological index regarding a physiological phenomenon such as yawning on the basis of the estimated posture of the student.

As described above, when receiving the student data from the student terminal device 3, the student characteristic identification unit 51 identifies a student identification on the basis of the received student data and stores the student identification in the storage unit 43. Note that the student characteristic may be identified in advance before the degree-of-listening calculation processing or in parallel with the degree-of-listening calculation processing.

Further, each student characteristic item and the specification method thereof described above are merely examples, and another student characteristic item may be identified, or each student characteristic item may be identified by another method.

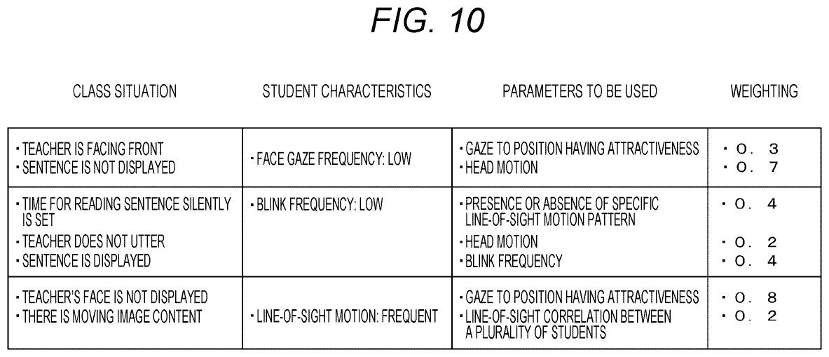

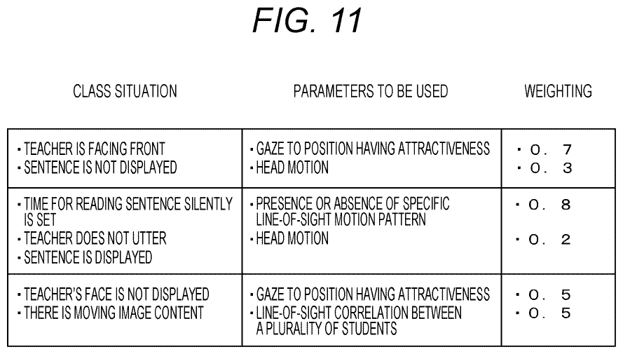

FIGS. 10 and 11 show an example of determining parameters to be used. Based on the class situation identified by the class situation identification unit 50 and the student characteristic identified by the student characteristic identification unit 51, the estimation method determination unit 52 determines any one of a plurality of parameters for calculating the degree of listening and determines weighting of the determined parameter.

As shown in FIG. 8, the parameters include a line-of-sight correlation, a gaze to a position having attractiveness, an expression, line-of-sight position accumulation, body or head motion, blink frequency or duration, a specific line-of-sight motion pattern, and the like. Note that the line-of-sight correlation, the gaze to the position having attractiveness, and the line-of-sight position accumulation can be described as parameters regarding a line-of-sight of the student.

For example, as shown in FIG. 10, in a class situation in which the teacher is speaking while facing front and a sentence such as a text is not displayed, it is estimated that a student having a low face gaze frequency is highly likely not to view the class screen 60. Therefore, the estimation method determination unit 52 determines the gaze to the position having attractiveness (teacher's face) and the head motion (presence or absence of nodding) as the parameters. Further, the parameter value calculation unit 53 weights the weight of the gaze to the position having attractiveness as 0.3 and the weight of the head motion as 0.7.

Further, in a class situation in which the teacher sets a time for reading a sentence silently, the teacher does not utter, and a sentence such as a text is displayed, it is estimated that a student having a low blink frequency is highly likely to read the sentence on the class screen 60. Therefore, the estimation method determination unit 52 determines the presence or absence of the specific line-of-sight motion pattern (motion pattern for reading a sentence), the head motion (the presence or absence of motion for bringing the face closer to the screen), and the blink frequency as the parameters. Further, the estimation method determination unit 52 weights the presence or absence of the specific line-of-sight motion pattern as 0.4, the weight of the head motion as 0.2, and the weight of the blink frequency as 0.4.

Further, in a class situation in which the teacher's face is not displayed on the class screen 60 and there is moving image content, it is estimated that a student whose line-of-sight frequently moves is highly likely to gaze at the moving image content. Therefore, the estimation method determination unit 52 determines the gaze to the position having attractiveness (a specific image of the moving image content) and the line-of-sight correlation between a plurality of students as the parameters. Further, the estimation method determination unit 52 weights the weight of the gaze to the position having attractiveness as 0.8 and the line-of-sight correlation between the plurality of students as 0.2.

The estimation method determination unit 52 may determine any one of a plurality of parameters for calculating the degree of listening and weighting of the determined parameter on the basis of only the class situation identified by the class situation identification unit 50.

For example, as shown in FIG. 11, in a class situation in which the teacher is speaking while facing front and a sentence such as text is not displayed, the estimation method determination unit 52 determines the gaze to the position having attractiveness (teacher's face) and the head motion (presence or absence of nodding) as the parameters. Further, the parameter value calculation unit 53 weights the weight of the gaze to the position having attractiveness as 0.7 and the weight of the head motion as 0.3.

Further, in a class situation in which the teacher sets a time for reading a sentence silently, the teacher does not utter, and a sentence such as a text is displayed, the estimation method determination unit 52 determines the presence or absence of the specific line-of-sight motion pattern (motion pattern for reading a sentence) and the head motion (the presence or absence of motion for bringing the face closer to the screen) as the parameters. Further, the estimation method determination unit 52 weights the presence or absence of the specific line-of-sight motion pattern as 0.8 and the weight of the head motion as 0.2.

Further, in a class situation in which the teacher's face is not displayed on the class screen 60 and there is moving image content, the estimation method determination unit 52 determines the gaze to the position having attractiveness (a specific image of the moving image content) and the line-of-sight correlation between a plurality of students as the parameters. Further, the estimation method determination unit 52 weights the weight of the gaze to the position having attractiveness as 0.5 and the weight of the line-of-sight correlation between the plurality of students as 0.5.

The parameter value calculation unit 53 calculates a parameter value of the determined parameter. Note that the parameter value is normalized in a range from the lowest 0 to the highest 1.

For example, in a case where the line-of-sight correlation is determined as the parameter, for example, the parameter value calculation unit 53 normalizes a correlation value of line-of-sight information with another student using the Pearson product-moment correlation coefficient and calculates the normalized correlation value as a parameter value.

Further, in a case where the line-of-sight to the position having attractiveness is determined as the parameter, the parameter value calculation unit 53 determines the position having attractiveness from the class screen 60 by image analysis or the like, normalizes a shift amount between the determined position having attractiveness and a point of gaze of a student on the class screen 60 based on the line-of-sight information, and calculates its parameter value.

Further, in a case where the expression is determined as the parameter, the parameter value calculation unit 53 identifies facial expressions of the teacher and the student from the class moving image and the student moving image by using a face recognition technology. Then, the parameter value calculation unit 53 normalizes a degree of matching between the facial expressions of the teacher and the student and calculates the degree of matching as a parameter value.

Further, in a case where the line-of-sight position accumulation is determined as the parameter, the parameter value calculation unit 53 calculates a parameter value by normalizing how much the student is viewing the same position on the basis of the line-of-sight information.

Further, in a case where the body or head motion is determined as the parameter, the parameter value calculation unit 53 detects and normalizes the presence or absence of a specific body or head motion by using a posture detection technology from the student moving image, thereby calculating its parameter value.

Further, in a case where the blink frequency or duration is determined as the parameter, the parameter value calculation unit 53 calculates and normalizes the blink frequency or duration from the student moving image by using the expression recognition technology, thereby calculating its parameter value.

Further, in a case where the presence or absence of the specific line-of-sight motion pattern is determined as the parameter, the parameter value calculation unit 53 normalizes the presence or absence of the specific line-of-sight motion pattern on the basis of the line-of-sight information, thereby calculating its parameter value.

The degree-of-interest estimation unit 54 multiplies the parameter value calculated by the parameter value calculation unit 53 and the weight of the parameter determined by the estimation method determination unit 52 for each parameter and adds multiplied values together, thereby calculating the degree of listening (any value between 0 and 1).

The degree of listening calculated here indicates that the student is not listening to a class as the value is closer to 0 and that the student is listening to a class as the value is closer to 1.

### 6.2. Notification Processing

When the degree of listening is calculated by the degree-of-interest estimation unit 54, the notification unit 55 makes a notification based on the calculated degree of listening to the teacher terminal device 2.

Note that, before making a notification based on the degree of listening to the teacher terminal device 2, the notification unit 55 can make a notification to the student terminal device 3 used by a student whose degree of listening is low to reconfirm whether or not the student is viewing the class.

Here, a threshold for determining whether or not the student is viewing the class is set. Further, a predetermined value a for providing a range to the threshold is set together. In a case where the degree of listening is equal to or less than (threshold−α), it is determined that the student is obviously not viewing the class. Meanwhile, when the degree of listening falls within (threshold±α), the student may not be viewing the class, and thus a notification for reconfirming the degree of listening is made.

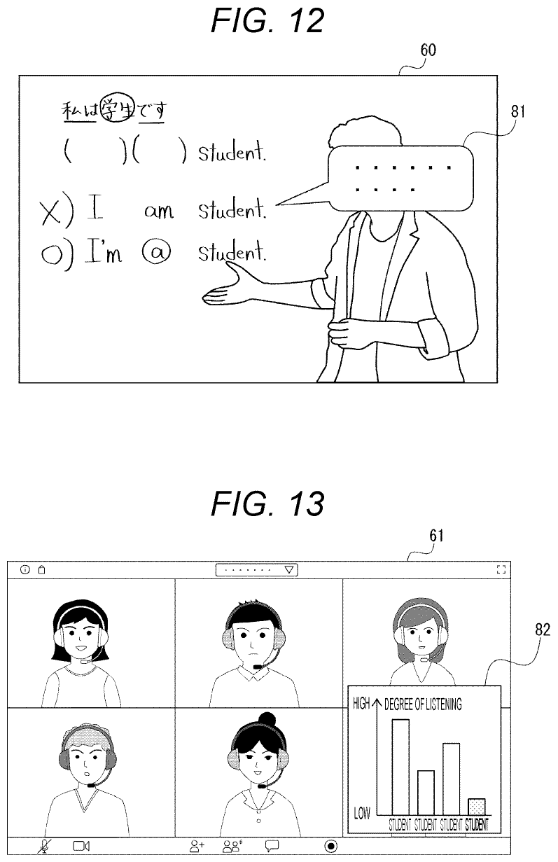

FIG. 12 shows a notification at the time of reconfirming the degree of listening. In the student terminal device 3 to which the notification for reconfirming whether or not the student is viewing the class has been made, as shown in FIG. 12, the class screen 60 in which a caption image 81 for leading the line-of-sight is superimposed on a scene of the class is displayed.

Then, the CPU 40 of the server 4 calculates the degree of listening again on the basis of student data transmitted after the caption image 81 is displayed.

Therefore, if the student is viewing the class, the student notices the presence of the caption image 81 and moves the line-of-sight to the class screen 60. Thus, the degree of listening increases. Meanwhile, if the student is not viewing the class, the student does not notice the presence of the caption image 81, and the degree of listening remains low.

Note that data of the caption image 81 may be stored in advance in the teacher terminal device 2 or the server 4 and be transmitted to the student terminal device 3 or may be generated according to a class situation in the teacher terminal device 2 or the server 4.

Further, the caption image 81 desirably has a content that does not make the student notice that the degree of listening is reconfirmed.

Next, specific examples of the notification based on the degree of listening calculated by the degree-of-interest estimation unit 54 will be described.

FIG. 13 shows a first example of the notification of the degree of listening. In the first example, the notification unit 55 transmits data of a degree-of-listening notification image 82 in which a calculated degree of listening is plotted as a bar graph to the teacher terminal device 2.

The teacher terminal device 2 that has received the data of the degree-of-listening notification image 82 displays the degree-of-listening notification image 82 on a part of the student screen 61 as shown in FIG. 13. In the degree-of-listening notification image 82, a graph having the degree of listening equal to or less than (threshold−α) is shown in a color different from those of other graphs. Therefore, it is possible to cause the teacher to instantaneously grasp that there is a student whose degree of listening is low.

Further, in a case where there is a student having the degree of listening equal to or less than (threshold-a), the notification unit 55 transmits an instruction to output a predetermined voice from the speaker 28 to the teacher terminal device 2. Therefore, it is possible to cause the teacher to instantaneously grasp that there is a student whose degree of listening is low.

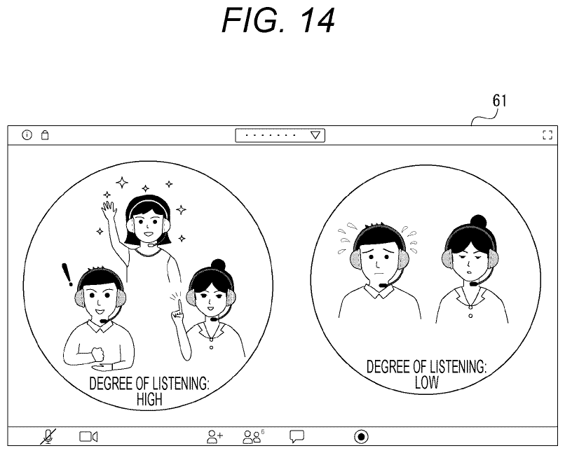

FIG. 14 shows a second example of the notification of the degree of listening. In the second example, the notification unit 55 transmits, to the teacher terminal device 2, information in which, for example, students having the degree of listening equal to or more than the threshold and students having the degree of listening less than the threshold are grouped.

Then, in the teacher terminal device 2, as shown in FIG. 14, a student image having the degree of listening equal to or more than the threshold (high) and a student image having the degree of listening less than the threshold (low) are separately displayed on the student screen 61 on the basis of the grouped information.

Therefore, it is possible to cause the teacher to easily grasp a student who is viewing the class and a student who is not viewing the class.

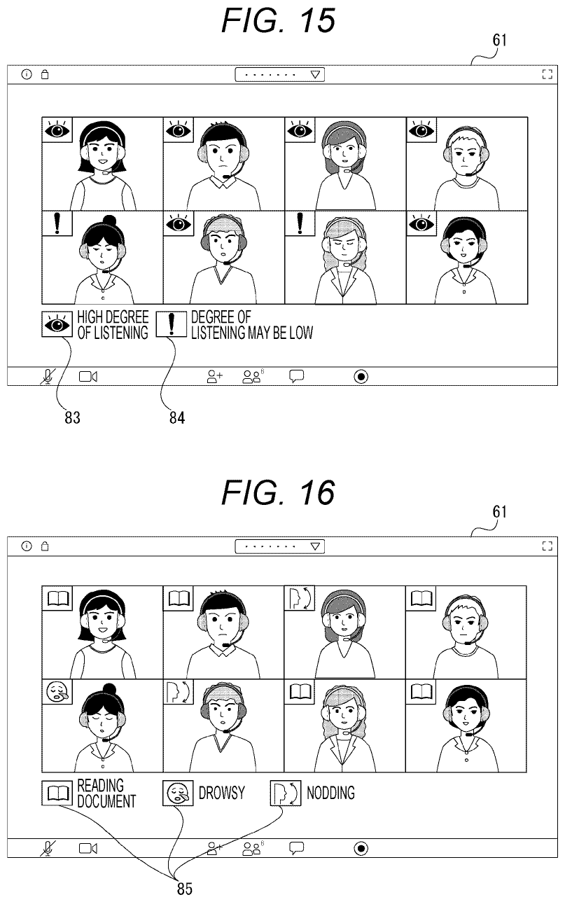

FIG. 15 shows a third example of the notification of the degree of listening. In the third example, the notification unit 55 transmits information indicating, for example, a student having the degree of listening equal to or more than the threshold and a student having the degree of listening less than the threshold to the teacher terminal device 2, thereby displaying a viewing icon 83 or a non-viewing icon 84 with each student image.

As shown in FIG. 15, the teacher terminal device 2 displays the viewing icon 83 indicating that a student having the degree of listening equal to or more than the threshold is viewing the class, for example, with a student image of the student. Further, the teacher terminal device 2 displays the non-viewing icon 84 indicating that a student having the degree of listening less than the threshold is not viewing the class, for example, with a student image of the student.

Therefore, it is possible to cause the teacher to easily grasp a student who is viewing the class and a student who is not viewing the class.

FIG. 16 shows a fourth example of the notification of the degree of listening. In the fourth example, the notification unit 55 makes a notification based on a parameter used to calculate the degree of listening. For example, in a case where there is a line-of-sight pattern for reading a sentence as the line-of-sight motion pattern of a specific student, the notification unit 55 transmits information indicating that the sentence is being read in association with the student to the teacher terminal device 2. Further, in a case where high blink frequency is identified, the notification unit 55 transmits information indicating that a student feels drowsy in association with the student to the teacher terminal device 2. Further, in a case where head nodding motion is detected, the notification unit 55 transmits information indicating the presence of nodding in association with the student to the teacher terminal device 2.

Then, when receiving information based on the parameter, the teacher terminal device 2 displays a parameter icon 85 corresponding to the information based on the parameter with a student image as shown in FIG. 16. Therefore, the teacher can easily grasp a state of the student.

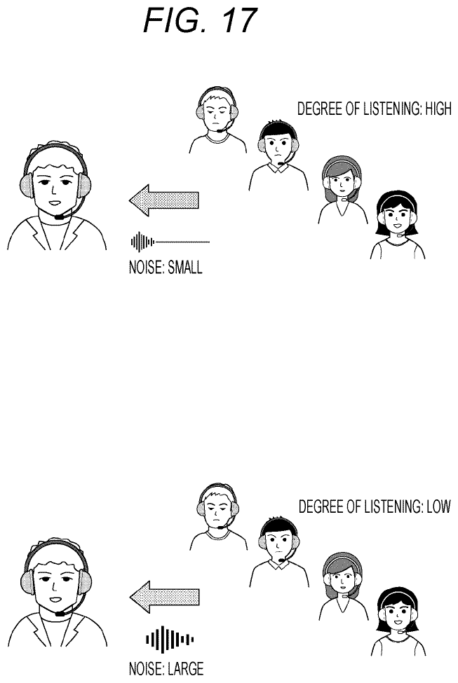

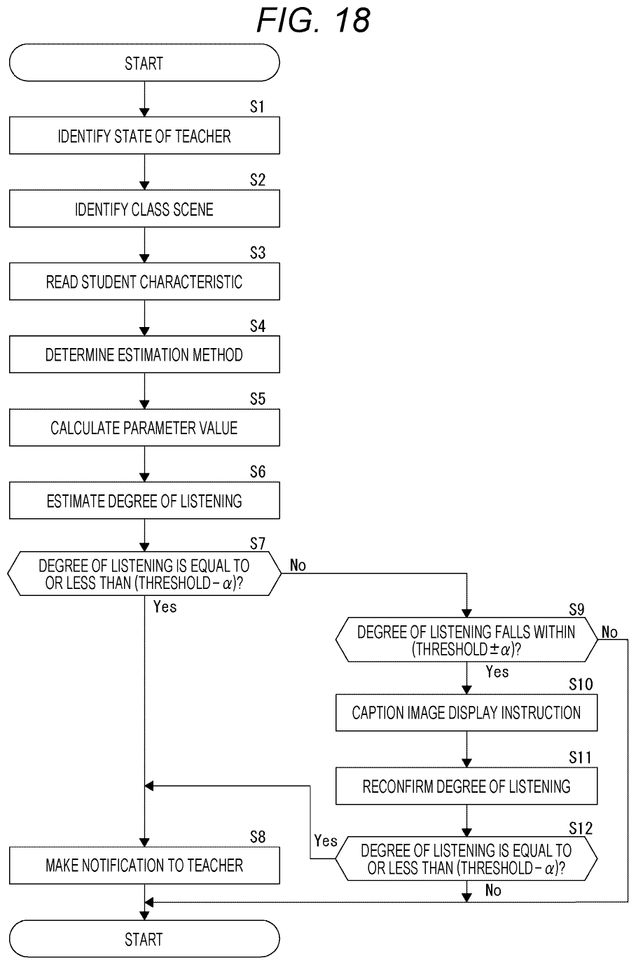

FIG. 17 shows a fifth example of the notification of the degree of listening. In the fifth example, an instruction is issued to the teacher terminal device 2 to cause the speaker 28 to output noise at a volume corresponding to the degree of listening. For example, as shown in FIG. 17, the notification unit 55 calculates an average value of the degree of listening of all students and issues an instruction to the teacher terminal device 2 such that the volume of noise is increased as the calculated average value of the degree of listening is decreased. The teacher terminal device 2 that has received the instruction outputs noise from the speaker 28 at the volume indicated by the instruction.

Therefore, the teacher can take an action to, for example, suggest naming a student in a case where the noise is large. That is, the notification unit 55 allows the teacher to employ such a use method that increases the degree of listening of the student and decreases the noise.

### 7. Flow of Degree-of-Interest Estimation Notification Processing

FIG. 18 is a flowchart showing a flow of the degree-of-interest estimation notification processing. The CPU 40 of the server 4 executes the degree-of-interest estimation notification processing, for example, at predetermined intervals, when a scene of a class changes (when the scene is switched), for each frame of a transmitted class moving image, or the like.

As shown in FIG. 18, the class situation identification unit 50 identifies a state of a teacher on the basis of class data in step S1 and identifies a class scene on the basis of the class data in step S2. That is, in steps S1 and S2, the class situation identification unit 50 identifies a class situation on the basis of the class data.

In step S3, the estimation method determination unit 52 reads a student characteristic stored in the storage unit 43. Note that the student characteristic is identified in advance by the student characteristic identification unit 51.

In step S4, the estimation method determination unit 52 determines a parameter used to calculate the degree of listening and weighting of the parameter on the basis of the class situation identified in steps S1 and S2 and the student characteristic read in step S3.

In step S5, the parameter value calculation unit 53 calculates a parameter value of the parameter determined in step S4. Then, in step S6, the degree-of-interest estimation unit 54 calculates the degree of listening on the basis of the calculated parameter value and weighting.

In step S7, the notification unit 55 determines whether or not the calculated degree of listening is equal to or less than (threshold−α). As a result, in a case where the degree of listening is equal to or less than (threshold−α) (Yes in step S7), in step S8, the notification unit 55 makes a notification to the teacher terminal device 2 as in the above first to fifth examples and makes a notification based on the degree of listening to the teacher.

Meanwhile, in a case where the degree of listening is not equal to or less than (threshold−α) (No in step S7), in step S9, the notification unit 55 determines whether or not the degree of listening falls within (threshold±α). Then, in a case where the degree of listening falls within (threshold±α) (Yes in step S9), in step S10, the notification unit 55 instructs the student terminal device 3 used by the student whose degree of listening falls within (threshold±α) to display the caption image 81 for reconfirming the degree of listening. Thereafter, in step S11, the degree-of-interest estimation unit 54 calculates the degree of listening again.

In step S12, the notification unit 55 determines whether or not the reconfirmed degree of listening is equal to or less than (threshold−α). As a result, in a case where the degree of listening is equal to or less than (threshold−α) (Yes in step S12), the processing proceeds to step S8.

In a case where the degree of listening does not fall within (threshold±α) (No in step S9) or in a case where the reconfirmed degree of listening is not equal to or less than (threshold−α) (No in step S12), the processing ends.

### 8. Another Configuration Example of Online Class System 1

Note that the embodiment is not limited to the specific examples described above and may be configured as various modification examples.

For example, the online class system 1 includes the server 4. However, the online class system 1 may not include the server 4. In that case, the CPU 20 of the teacher terminal device 2 or the CPU 30 of the student terminal device 3 is only required to function as the student characteristic identification unit 51, the estimation method determination unit 52, the parameter value calculation unit 53, the degree-of-interest estimation unit 54, and the notification unit 55.

Further, the CPU 20 of the teacher terminal device 2, the CPU 30 of the student terminal device 3, and the CPU 40 of the server 4 may function in cooperation as the student characteristic identification unit 51, the estimation method determination unit 52, the parameter value calculation unit 53, the degree-of-interest estimation unit 54, and the notification unit 55.

Further, in the above embodiment, a viewer is caused to view a class moving image and a class voice as content. However, the content is not limited thereto and may be another kind of content.

### 9. Summary of Embodiment

As described above, an information processing device (server 4) according to the embodiment includes: the estimation method determination unit 52 that determines an estimation method for estimating the degree of interest (degree of listening) of a viewer (student) who views content on the basis of at least a situation of the content (class situation); and the degree-of-interest estimation unit 54 that estimates the degree of interest on the basis of the estimation method and a plurality of parameters including a parameter regarding a line-of-sight of the viewer.

Therefore, the server 4 can determine an optimal estimation method according to the class situation. That is, the server 4 can reflect the class situation and thus accurately estimate the degree of interest.

Further, the estimation method determination unit 52 determines the estimation method on the basis of the situation of the content and a characteristic of the viewer (student characteristic).

Therefore, the server 4 can determine an optimal estimation method according to the class situation and a characteristic of each student. That is, the server 4 can reflect the class situation and the student identification and thus more accurately estimate the degree of interest.

Further, the estimation method determination unit 52 determines any one of the plurality of parameters on the basis of at least the situation of the content, and the degree-of-interest estimation unit 54 estimates the degree of interest on the basis of the determined parameter.

Therefore, the server 4 estimates the degree of interest on the basis of the parameter optimal for the class situation among the plurality of parameters and thus can more accurately estimate the degree of interest.

Further, the estimation method determination unit 52 determines any one of the plurality of parameters and weighting of the determined parameter on the basis of at least the situation of the content, and the degree-of-interest estimation unit 54 estimates the degree of interest on the basis of the determined parameter and the determined weighting.

Therefore, the server 4 estimates the degree of interest on the basis of the parameter optimal for the class situation among the plurality of parameters and the weighting and thus can more accurately estimate the degree of interest.

Further, the estimation method determination unit 52 determines the estimation method when the situation of the content changes.

Therefore, the server 4 can estimate the degree of interest by a new estimation method when the class situation changes and thus can estimate the degree of interest further in consideration of the class situation.

Further, the estimation method determination unit 52 determines an estimation method at predetermined intervals.

Therefore, even if the class situation changes, the server 4 can calculate the degree of interest according to the changed class situation.

Further, the server 4 includes the notification unit 55 that notifies a provider (teacher) who provides the content on the basis of the degree of interest.

Therefore, the teacher can easily grasp the degree of interest of the student.

Further, the notification unit 55 makes a notification for reconfirming the degree of interest to a viewer whose degree of interest is low.

Therefore, the server 4 can lead the viewer whose degree of interest is low to view the content.

Further, the notification unit 55 makes a notification of the degree of interest to the provider.

Therefore, the server 4 allows the teacher to easily grasp the degree of interest of the student.

Further, the notification unit 55 separately makes a notification of the viewer whose degree of interest is high and the viewer whose degree of interest is low.

Therefore, the server 4 allows the teacher to easily distinguish and grasp the viewer whose degree of interest is high and the viewer whose degree of interest is low.

Further, the notification unit 55 displays an icon corresponding to the degree of interest of the viewer.

Therefore, the server 4 allows the teacher to easily grasp the degree of interest of the student.

Further, the notification unit 55 displays an icon corresponding to the parameter of the viewer.

Therefore, the server 4 allows the teacher to easily grasp a state of the student regarding the parameter.

Further, the notification unit 55 makes a voice notification at a volume corresponding to the degree of interest.

Therefore, the server 4 allows the teacher to easily grasp the degree of interest of the student on the basis of the volume.

As described above, in an information processing method according to the embodiment, an information processing device determines an estimation method on the basis of at least a situation of content and estimates a degree of interest of a viewer who views the content on the basis of the estimation method and a plurality of parameters including a parameter regarding a line-of-sight of the viewer.

As described above, a program according to the embodiment determines an estimation method on the basis of at least a situation of content and estimates a degree of interest of a viewer who views the content on the basis of the estimation method and a plurality of parameters including a parameter regarding a line-of-sight of the viewer.

Such a program can be recorded in advance in an HDD as a recording medium built in a device such as a computer device, a ROM in a microcomputer including a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, a memory card, or the like. Such a removable recording medium can be provided as so-called packaged software.

Further, such a program may be installed from the removable recording medium into a personal computer or the like or may be downloaded from a download site via a network such as a local area network (LAN) or the Internet.

Note that the effects described in the present specification are merely examples and are not limited, and there may be other effects.

### 10. Present Technology

The present technology may also adopt the following configurations.
(1)

An information processing device including:

an estimation method determination unit that determines an estimation method for estimating a degree of interest of a viewer who views content on the basis of at least a situation of the content; and

a degree-of-interest estimation unit that estimates the degree of interest on the basis of the estimation method and a plurality of parameters including a parameter regarding a line-of-sight of the viewer.
(2)

The information processing device according to (1), in which

the estimation method determination unit determines the estimation method on the basis of the situation of the content and a characteristic of the viewer.
(3)

The information processing device according to (1) or (2), in which:

the estimation method determination unit determines any one of the plurality of parameters on the basis of at least the situation of the content; and

the degree-of-interest estimation unit estimates the degree of interest on the basis of the determined parameter.
(4)

The information processing device according to (3), in which:

the estimation method determination unit determines any one of the plurality of parameters and weighting of the determined parameter on the basis of at least the situation of the content; and

the degree-of-interest estimation unit estimates the degree of interest on the basis of the determined parameter and the determined weighting.
(5)

The information processing device according to any one of (1) to (4), in which

the estimation method determination unit determines the estimation method when the situation of the content changes.
(6)

The information processing device according to any one of (1) to (4), in which

the estimation method determination unit determines the estimation method at predetermined intervals.
(7)

The information processing device according to any one of (1) to (6), further including

a notification unit that makes a notification to a provider who provides the content on the basis of the degree of interest.
(8)

The information processing device according to (7), in which

the notification unit makes a notification for reconfirming the degree of interest to the viewer whose degree of interest is low.
(9)

The information processing device according to (7) or (8), in which

the notification unit makes a notification of the degree of interest to the provider.
(10)

The information processing device according to any one of (7) to (9), in which

the notification unit separately makes a notification of the viewer whose degree of interest is high and the viewer whose degree of interest is low.
(11)

The information processing device according to any one of (7) to (10), in which

the notification unit displays an icon corresponding to the degree of interest of the viewer.
(12)

The information processing device according to any one of (7) to (11), in which

the notification unit displays an icon corresponding to the parameter of the viewer.
(13)

The information processing device according to any one of (7) to (12), in which

the notification unit makes a voice notification at a volume corresponding to the degree of interest.
(14)

An information processing method including,

by an information processing device:

determining an estimation method on the basis of at least a situation of content; and

estimating a degree of interest of a viewer who views the content on the basis of the estimation method and a plurality of parameters including a parameter regarding a line-of-sight of the viewer.
(15)

A program for causing an information processing device to execute processing of:

determining an estimation method on the basis of at least a situation of content; and

estimating a degree of interest of a viewer who views the content on the basis of the estimation method and a plurality of parameters including a parameter regarding a line-of-sight of the viewer.

### REFERENCE SIGNS LIST

1 Online class system
2 Teacher terminal device
3 Student terminal device
4 Server
40 CPU
50 Class situation identification unit
51 Student characteristic identification unit
52 Estimation method determination unit
53 Parameter value calculation unit
54 Degree-of-interest estimation unit
55 Notification unit claims

1. An information processing device comprising:
an estimation method determination unit that determines an estimation method for estimating a degree of interest of a viewer who views content on a basis of at least a situation of the content; and
a degree-of-interest estimation unit that estimates the degree of interest on a basis of the estimation method and a plurality of parameters including a parameter regarding a line-of-sight of the viewer.

2. The information processing device according to claim 1, wherein
the estimation method determination unit determines the estimation method on a basis of the situation of the content and a characteristic of the viewer.

3. The information processing device according to claim 1, wherein:
the estimation method determination unit determines any one of the plurality of parameters on a basis of at least the situation of the content; and
the degree-of-interest estimation unit estimates the degree of interest on a basis of the determined parameter.

4. The information processing device according to claim 3, wherein:
the estimation method determination unit determines any one of the plurality of parameters and weighting of the determined parameter on a basis of at least the situation of the content; and
the degree-of-interest estimation unit estimates the degree of interest on a basis of the determined parameter and the determined weighting.

5. The information processing device according to claim 1, wherein
the estimation method determination unit determines the estimation method when the situation of the content changes.

6. The information processing device according to claim 1, wherein
the estimation method determination unit determines the estimation method at predetermined intervals.

7. The information processing device according to claim 1, further comprising
a notification unit that makes a notification to a provider who provides the content on a basis of the degree of interest.

8. The information processing device according to claim 7, wherein
the notification unit makes a notification for reconfirming the degree of interest to the viewer whose degree of interest is low.

9. The information processing device according to claim 7, wherein
the notification unit makes a notification of the degree of interest to the provider.

10. The information processing device according to claim 7, wherein
the notification unit separately makes a notification of the viewer whose degree of interest is high and the viewer whose degree of interest is low.

11. The information processing device according to claim 7, wherein
the notification unit displays an icon corresponding to the degree of interest of the viewer.

12. The information processing device according to claim 7, wherein
the notification unit displays an icon corresponding to the parameter of the viewer.

13. The information processing device according to claim 7, wherein
the notification unit makes a voice notification at a volume corresponding to the degree of interest.

14. An information processing method comprising,
by an information processing device:
determining an estimation method on a basis of at least a situation of content; and
estimating a degree of interest of a viewer who views the content on a basis of the estimation method and a plurality of parameters including a parameter regarding a line-of-sight of the viewer.

15. A program for causing an information processing device to execute processing of:
determining an estimation method on a basis of at least a situation of content; and
estimating a degree of interest of a viewer who views the content on a basis of the estimation method and a plurality of parameters including a parameter regarding a line-of-sight of the viewer.
